(19) United States
(12) Patent Application Publication
(10) Pub. No.: US 2012/0229258 A1
(43) Pub. Date: Sep. 13, 2012

(54) PROXIMITY DETECTION APPARATUS AND METHOD AND ASSET MANAGEMENT APPARATUS

(76) Inventors: Ser Yong LIM, Singapore (SG); Wei Liu, Singapore (SG)

(21) Appl. No.: 13/415,770

(22) Filed: Mar. 8, 2012

(30) Foreign Application Priority Data
Mar. 8, 2011 (SG) 201101718-3
Mar. 15, 2011 (SG) 201101854-6

(51) Int. Cl. G06K 7/01

(52) U.S. Cl. 340/10.1

(57) ABSTRACT

Proximity detection apparatus 100 and method is disclosed herein. In a first embodiment, the proximity detection apparatus 100 is for tracking location of subjects tagged with respective transponders. The apparatus 100 comprises a radio frequency (RF) antenna 102 configured to transmit a RF signal for sensing presence of a subject, a sensing circuit 106 configured to detect detuning of the RF antenna 102 and to derive a parameter associated with the RF signal which is representative of the detuning; and a control system 110,112 configured to compare the parameter with a threshold and based on the comparison, determine whether to initiate an inventor check to locate the subjects.

### FIELD

This invention relates to proximity detection apparatus and method, more particularly but not exclusively, for sensing presence of human subjects. An asset management apparatus is also disclosed.

### BACKGROUND

Proximity detection enables a system to make a decision based on relative distance between an object and a proximity sensor. Based on the detection, the system then decides to enable or disable system features.

However, current systems tend to result in “RF pollution”, inefficient in power management and long “scan” time to poll the inventory.

There is therefore a need to provide a proximity detection apparatus and method which addressees at least one of the disadvantages of the prior art and/or to provide the public with a useful choice.

### SUMMARY

In accordance with a first aspect, there is provided a proximity detection apparatus comprising a radio frequency (RF) antenna configured to transmit a RF signal for sensing presence of a subject; a sensing circuit configured to detect detuning of the RF antenna and to derive a parameter associated with the RF signal which is representative of the detuning; and a control system configured to compare the parameter with a threshold and based on the comparison, determine whether to control the RF antenna to transmit a signal for initiating a predetermined event.

As described in the preferred embodiment, this achieves a more efficient manner of tracking objects and thus, achieves great power savings.

By proximity detection, this means between 0-50 cm of the location of the RF antenna. It should be appreciated that “antenna” is used herein to mean “transducers”, transmitters/receivers or transceivers etc.

Preferably, the parameter is selected from the group consisting of frequency, phase and amplitude of the RF signal. The apparatus may be used for tracking locations of targets tagged with respective transponders, and wherein the predetermined event may include interrogation of the transponders to determine the locations of the corresponding targets, the control signal being used to trigger the interrogation. Preferably, the targets may be selected from at least one of the group consisting of objects, human beings and animals.

The sensing circuit may include a filter for filtering the return loss component to obtain a filtered actuating signal. The filter may include a low pass filter for attenuating high frequency noise components.

The sensing circuit may include a buffer for buffering the filtered actuating signal to produce a buffered actuating signal. Specifically, the sensing circuit may include an analog-to-digital converter for digitizing the buffered actuating signal to produce the actuating signal.

Preferably, the apparatus further comprises a RF controller for switching the RF antenna between a first mode for sensing of the subject and a second mode for transmitting the signal in response to a triggering signal.

It should be appreciated that the subjects may be selected from at least one of the group consisting of objects, human beings and animals.

According to a second aspect, there is provided a proximity detection method comprising transmitting a RF signal by a RF antenna for sensing presence of a subject; detecting detuning of the RF antenna; deriving a parameter associated with the RF signal which is representative of the detuning; and comparing the parameter with a threshold and based on the comparison, determining whether to control the RF antenna to transmit a signal for initiating a predetermined event.

According to a third aspect, there is provided an asset management apparatus, comprising the apparatus of claim 1; a plurality of the RF antennas, each RF antenna transmitting a RF signal for detecting presence of a said subject, a plurality of multiplexer switches with each multiplexer switch communicatively coupled to some of the RF antennas, the multiplexer switch being configured to selectively allow each RF antenna to communicate with the control system in order for the respective parameters to be obtained, wherein the control system is configured to compare the respective parameters with the threshold and to generate the signal for interrogating transponders tagged to targets to determine locations of the targets.

It should be appreciated that features relating to one aspect may also be applicable to the other aspects.

### BRIEF DESCRIPTION OF THE DRAWINGS

Examples of the invention will now be described with reference to the accompanying drawings, in which:

FIG. 1 is a schematic diagram illustrating a proximity detection apparatus according to a first embodiment;

FIG. 2 is a block diagram of the apparatus of FIG. 1 which includes a sensing circuit having a low pass filter;

FIG. 3 is a schematic of the low pass filter of FIG. 2;

FIG. 4 is a block diagram of an asset management apparatus which includes the apparatus of FIG. 1;

FIG. 5 shows a structure of a “3D” antenna which is used in a second embodiment;

FIG. 6 shows the antenna of FIG. 5 with improved features;

FIG. 7 is a block diagram of an asset management apparatus which includes the antenna of FIG. 5 or 6; and thus, the apparatus is different from the apparatus of FIG. 4;

FIG. 8 illustrates how the antenna of FIG. 6 is mounted to a shelf and used as part of the asset management apparatus of FIG. 7; and

FIG. 9 illustrates an assembly of shelves having respective antennas of FIG. 6.

### DETAILED DESCRIPTION OF PREFERRED EMBODIMENTS

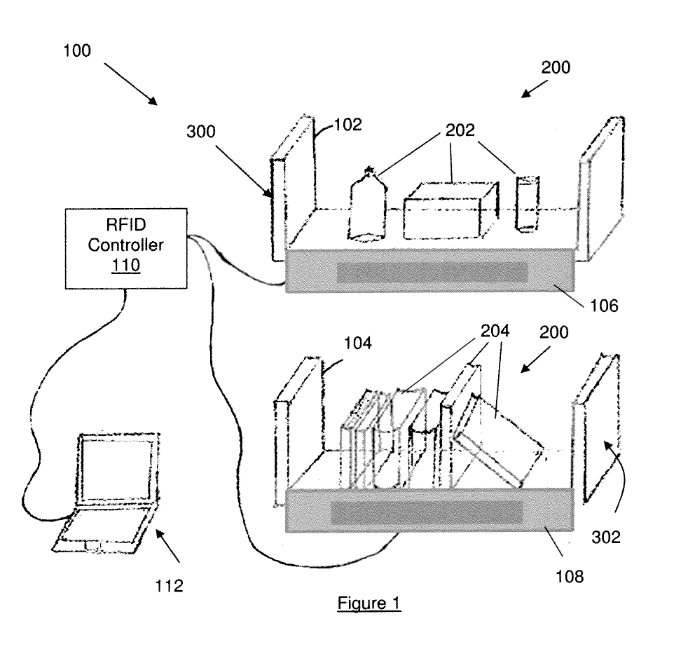

FIG. 1 illustrates a proximity sensing apparatus 100 and in a first embodiment, the apparatus 100 is configured to track locations of targets 200 which are objects 202 and books 204 placed respectively on a first shelf 300 and a second shelf 302. Each target 200 is tagged with a transponder in the form of an RFID tag (not shown). The targets 200 form part of an inventory database.

The apparatus 100 includes a RF antenna 102,104 at each shelf 300,302 for sensing presence of a subject, particularly for near-field detection of locations of the objects 202 and the books 204. The apparatus 100 further includes a sensing circuit 106,108 communicatively coupled to the corresponding RF antenna 102,104. The apparatus 100 further includes a control system including an RFID controller 110 communicatively coupled to the two sensing circuits 106,108 and a monitoring system 112. Since the two sensing circuits 106,108 and the corresponding RF antennas 102,104 are similar, only the sensing circuit 106 and the RF antenna 102 for tracking the location of the objects 202 are described.

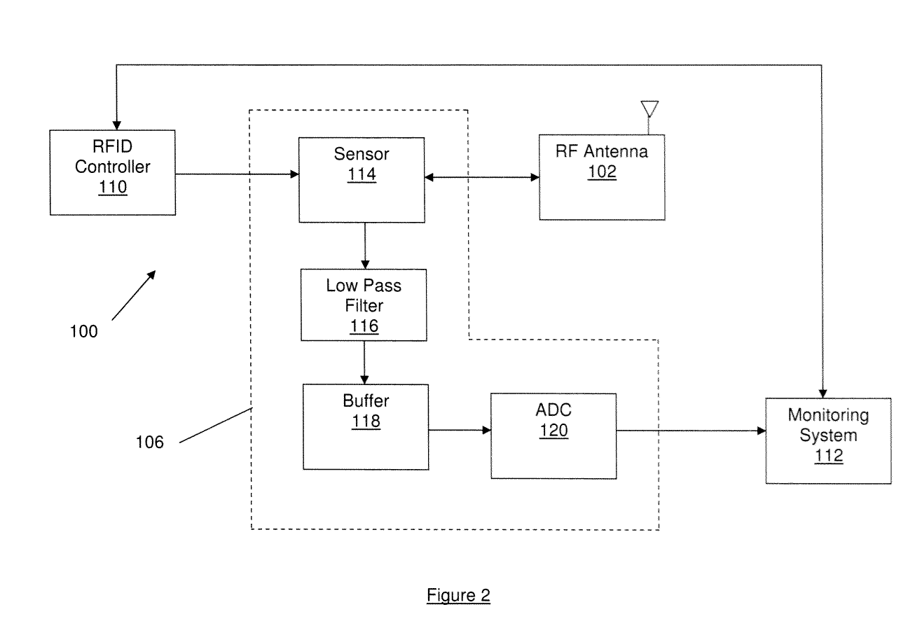

FIG. 2 is a block diagram of the apparatus 100 of FIG. 1 illustrating the RF antenna 102 coupled to the sensing circuit 106 and the RFID controller 110 coupled to the sensing circuit 106.

Normally, the RF antenna 102 is configured to detect presence of a subject, such as a person, and the RF controller 110 is configured to drive the RF antenna 102 at LF RFID, HF RFID and UHF RFID to generate and transmit a magnetic filed for detecting the person.

As it can be appreciated, the transmitted RF signal would be reflected by stationary objects, such as the shelf 300, within its magnetic field range and this causes detuning of the RF antenna 102. However, if a person moves within the magnetic field range, the RF signal is also reflected by the person, and the person's presence is detected as further detuning of the RF antenna 102.

In other words, it is possible to determine movement and/or presence of a person or object by measuring the amount of detuning of the RF antenna 102. The amount of detuning may be measured by way of a parameter of the RF signal for example, return loss component (i.e. amplitude), frequency and/or phase change of the RF signal.

The amount of detuning is measured by the sensing circuit 106 which includes a sensor 112 for measuring the reflected RF energy due to the detuning (i.e. near-field impedance change) of the antenna transducer 102. An example of the sensor 112 is a directional coupler for measuring the return loss component. In this embodiment, the return loss component (i.e. amplitude) is derived from the reflected RF energy (the return loss component being a difference between the transmitted RF energy and the reflected RF energy) and the return loss component is used by the sensor 112 to derive an actuating data signal.

It should be appreciated that the sensor 112 is “positioned between” the RFID controller 110 and the RF antenna 102 and it should be apparent that this may not mean physically but rather the electrical connection.

The sensor's output is coupled to a filter 116 for reducing noise voltage, spikes and spurs related to the return loss component to produce a filtered actuating data signal. In this embodiment, the filter 116 is a low pass filter, although other types of filters (such as band-pass filters) are also possible. The low pass filter 116 is arranged to attenuate high frequency contamination in the actuating data signal so that the filtered actuating data signal is of low frequency and a more accurate representation of the actuating data as a result of the detuning.

The sensing circuit 106 further includes a buffer 118, an Analog-to-Digital Converter (ADC) 120 for producing a digital actuating data signal which is transmitted to the monitoring system 112.

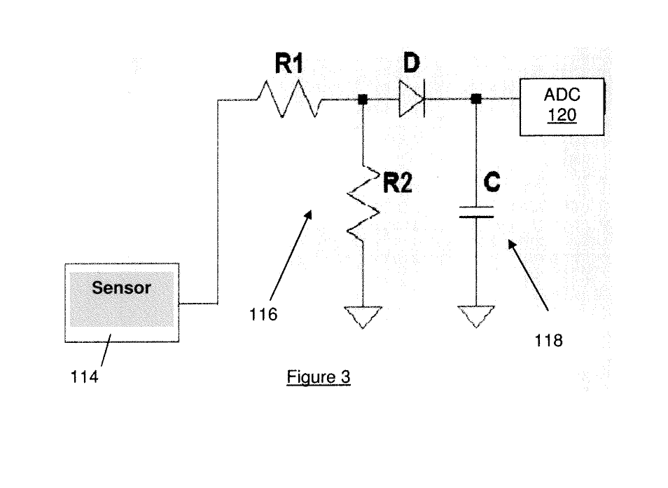

FIG. 3 illustrates a schematic diagram of the low pass filter 116 and the buffer 118 comprising resistors R1, R2, diode D and capacitor C with the output from the buffer 118 being delivered to the ADC 120.

The construction of the sensor 114 and the buffer 118 is used to stabilize the filtered actuating data signal and to drive the filtered actuating data signal into the ADC 120. The buffer 118 receives the filtered actuating data signal and produces a buffered actuating data signal for the ADC 120. The buffer 118 is configured with high input and low output impedance and thus, reduces loading effects on the filtered actuating data signal and the buffered actuating signal is fed directly into the ADC. This prevents the use of signal conditioning circuits for processing of the actuating data signal.

The ADC 120 is configured to digitize the buffered actuating data signal into the digital actuating data signal which is relatively much simpler and easier to be processed by the monitoring system 112.

The monitoring system 112 is a computing device such as a personal computer (PC) to monitor the amount of detuning and to initiate a predetermined event. It should be appreciated that the computing device may be a programmed microcontroller.

The monitoring system 112 is configured to receive the digital actuating data signal from the ADC 120 and to compare the digital actuating data signal with a threshold value of return loss which is preset or predetermined. If the digital actuating data signal is not within the threshold value, the monitoring system 112 is configured to send out a control or triggering signal.

In this respect, if the digital actuating data signal exceeds the threshold value, this means that the person is likely to be at the shelf 300 to retrieve any of the objects 202 or to add further objects 202 to the shelf. Thus, the monitoring system 112 transmits the triggering signal to the RFID controller 110 which is configured to drive the RF antenna 102 at LF RFID, HF RFID and UHF RFID in order to generate a tracking RF signal for interrogating the RFID tags tagged to the objects.

To elaborate, the RF antenna 102 is configured to generate and transmit a magnetic field in the near-field RF range of the antenna 102 with the wavelength of the magnetic field being more than the distance of the RFID tags of the objects 202.

In this way, the RF antenna 102 doubles up as a reader for locating the objects 202 or new ones being added to the shelf 300, and an inventory check is initiated as the predetermined event based on the triggering signal from the monitoring system 112. This also means that the RF antenna 102 is driven normally in a “sensing” or “detection” mode to detect presence of the person before switching to a “location tracking” or “asset management” mode in response to the triggering signal to perform a new cycle of checks for tagged inventory (i.e. the objects 202 and the books 204) leading to a refresh of the inventory database. In this way, substantial power savings may be achieved based on the use of the same antenna 102 for both tasks.

The preset threshold value is derived based on trial and error since the value depends on position, orientation and physical size of the subjects (or inventory to track). For example, tests may be carried out to determine what typical return loss component values represent a particular movement of the subjects 200 and a median value is chosen as the threshold value.

Alternatively described, the first embodiment includes a system to detect proximal object(s) or subject(s) that is/are preferably within the near field range of the antenna (eg. antenna or transducer), involving:
Detecting detuning of antenna or transducer (enabled by a sensor circuit)
   Detecting variation in load modulation to the antenna (e.g. when a Tag is moved or waved).
   Filtering return loss of antenna or transducer using a LPF or BPF
      Removing high frequency noise components
      Preserving actuating signal.
      [Location] between RFID controller & antenna
   Buffering the actuating signal (or return loss signal) to mitigate loading effect on the actuating signal using a Buffer or Driver;
      Buffer is of high input impedance and low output impedance.
   Digitizing the actuating signal using an ADC.
   Comparing the digitized actuating signal with a threshold for triggering purposes.
coupling of the reflected RF energy to a circuit to provide an actuating or trigger signal, which in turns actuate a system to power on. (enabled by a coupler)
buffering—avoids data loss (enabled by a Buffer). This provides an added advantage of preventing the loading effect on the actuating signal.

In the first embodiment, it is suggested that the RF antenna 102 is configured to detect or sense the presence of a person and to derive the antenna detuning in order to decide if the triggering signal is to be sent but it is also envisaged that instead of or in addition, the RF antenna 102 may be adapted to detect the movement of the objects 202 (or books 204). In other words, the threshold value is adjusted to take into account detuning of the RF antenna 102 caused by movement of an object 202 (due to retrieval by the person or new object being added) and only when the amount of detuning is representative of such movements, then the control or triggering signal is generated.

With the described embodiment, the actuating data signal is preserved from high frequency noise components and hence the required actuating data signal is less susceptible to distortion or loss of any data. This generally increases the apparatus reliability and hence the measured RF signal is optimized for accurate results. Further, since the sensing circuit 106 operates based on detuning of the RF antenna 102, this enables real time tracking of the tagged objects 202.

Furthermore, converting the actuating data signal into a digital signal makes it easier for the actuating data signal to be processed by the monitoring system 112. This paves the way for monitoring the inventory of the subjects 200 based on proximal detuning caused by load modulation of tagged components. The apparatus 100 may be used to list inventory based on automatic identification. Moreover, movement of tagged inventories can also be detected. This eliminates manual monitoring of inventory.

When movement of inventory/person is detected by the apparatus 100, the digital actuating data signal is compared with the threshold value and if movement of inventory is established, the triggering signal is generated. Moreover, the RF controller 110 may be programmed to be idle normally, and when detuning beyond the threshold value is detected, then the RF controller 110 is activated to refresh the inventory database. This results in significant power saving option for the apparatus 100.

With such an apparatus 100, warehouses, library shelves, chemical laboratories etc may not be monitored manually for a long time. Instead, the trigger can help in notifying users about the proximity of the subjects 200 as subjected to the near field effect of the RF antenna 102, resulting in a much more efficiency way of tracking locations of the subjects. It should be appreciated that the subjects 200 may not be objects 202 or things and the subjects 200 may include human beings or animals such as tagging of live cattle.

Areas of industrial applications include supply chains, B2B integration, RFID tracking and tracing, and in various manufacturing and inventory situations.

Indeed, an application of the apparatus 100 is in asset management.

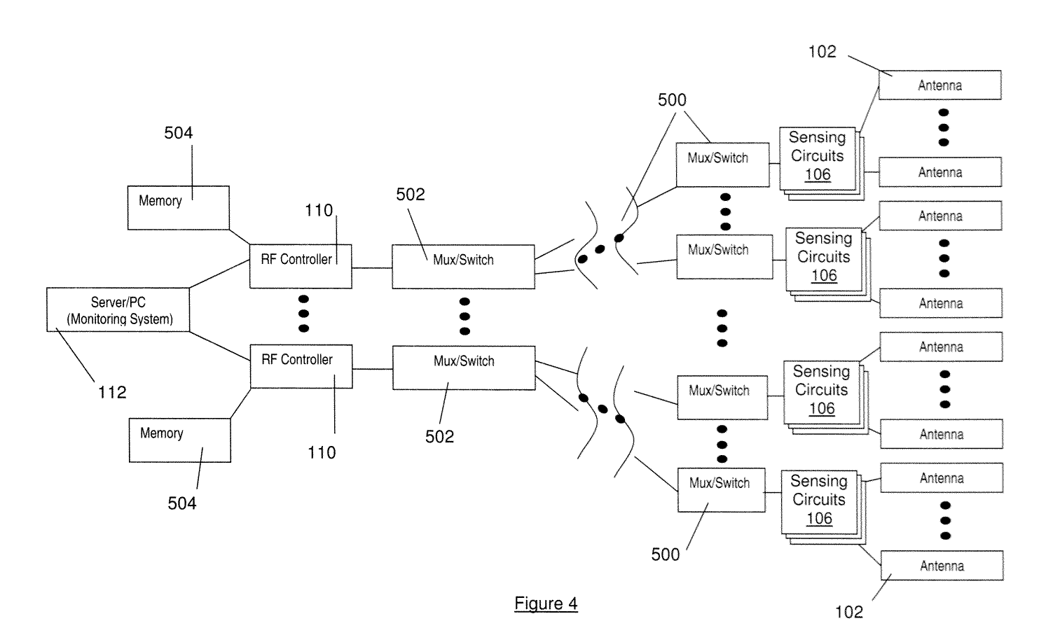

FIG. 4 is a block diagram of inter-connect of RAMS (RFID Asset Management System). Starting from the right hand side of the figure, multiple antennas 102 (with matching circuits) are attached to respective sensing circuits 106 and front end multiplexers/switches 500. Each multiplexer 500 may be connected to a multiple of antennas 102. The number of antennas 102 can be of any number that the multiplexers 500 can support. From the multiplexers 500, they can in turn be linked to more multiplexers 500. This form of cascading can go on to multiple levels depending on the requirements. At the and stage (left side of FIG. 4), there are end-stage multiplexers 512 coupled to the front end multiplexers 500, they are connected individually to one RF controller 110 each. The RF controllers 110 are then connected to a host which is the monitoring system 112.

To reduce the processing and handling load of the host, each individual RF controller has a localized memory 504 for storing of tag information passed down from the multiplexers 500,502 that are ultimately connected to the antennas 102. At the same time, each RF controller 110 is also responsible for the control of the multiplexers 500,502 that are cascaded to it. The RE controllers 110 and multiplexers 500,502 are synchronized with a common clock source for coordinated communication. This reduces the chance of dropped information and misread due to different clocking of the RF controllers 110 and the downstream multiplexers 500,502. This form of distributed control will ease the traffic traveling along the host to RF controllers and also reduce the demand of high processing power of the host 112.

To improve the reading speed and improve accuracy, an unique system synchronization methodology is used: i.e. using a master clock from the RF controller 110 to synchronize system scheduling and timing. The multiplexers 502,500 are configured to receive direct receive command from the RF controllers 110 instead of the host 112. This approach would provide better synchronization between the RF controllers 110 and the multiplexers 500,502, as compared to the traditional way of using the host 112 to synchronize both the RF controllers 110 and the multiplexers 500,502 which is not able to have precise synchronization timing.

To further improve the reading speed and improve accuracy, a matrix array list structure middleware methodology is adapted instead of a cascade structure. It will be automatic configuring and synchronizing system scheduling and timing by predefined matrix array. Traditional using cascade structure approach needs to configure different level multiplexers one level by one level which is very time consuming.

The use of the localized memory 504 further improves the reading speed and accuracy. Tag information is automatically stored inside the localization memory 504. Traditional approach is: whenever reads tag information and will be sending directly to PC that cost of heavy traffic for communication bus. The new approach is storing tag information inside the residential memory 504 as buffer and will be transmitting the tag information to the PC 112 whenever needed. So the reader possesses not only RFID controller, but also localized memory and processor for storage and also control of the cascaded multiplexers and antennas with synchronized clocking.

Instead of the apparatus 100 of the first embodiment, the asset management system may use a “3D” antenna which forms a second embodiment.

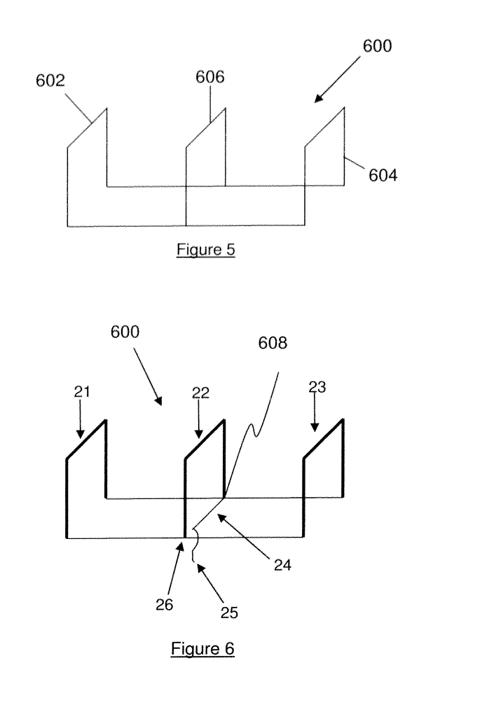

In FIG. 5, the proposed 3D antenna 600 is shown. It is made from metallic material not limited to copper, iron, aluminum or steel. The diameter of the wire may be varied to suit the applications depending on read range, number of transponders or tags, power level, surrounding objects and environment. For example, it has been found that antenna diameter in the range of AWG4/0 to AWG1/0 and AWG1 to AWG23 is preferred. The antenna 600 is constructed based on a rectangular loop with two ends 602,604 folded up to form a shape which has an ability to read tags placed in multiple orientations (lying down, up right, diagonal and facing out). Essentially, the antenna 600 is able to read tags in all the three dimensions, hence the 3D antenna name. In the center of the antenna, mid way between the two sides, is an additional bending 606 of wire and attached by any conductive means such as soldering or using an interconnecting metallic tube. Another way of constructing the 3D antenna is by using a single continuous wire and fold according to the shape in FIG. 6. This may be done by starting from the center and folding the antenna in a figure-of-eight manner. At the starting and ending points of the wire, any way of connecting them electrically to the center standing loop will complete the construction of the 3D antenna 600.

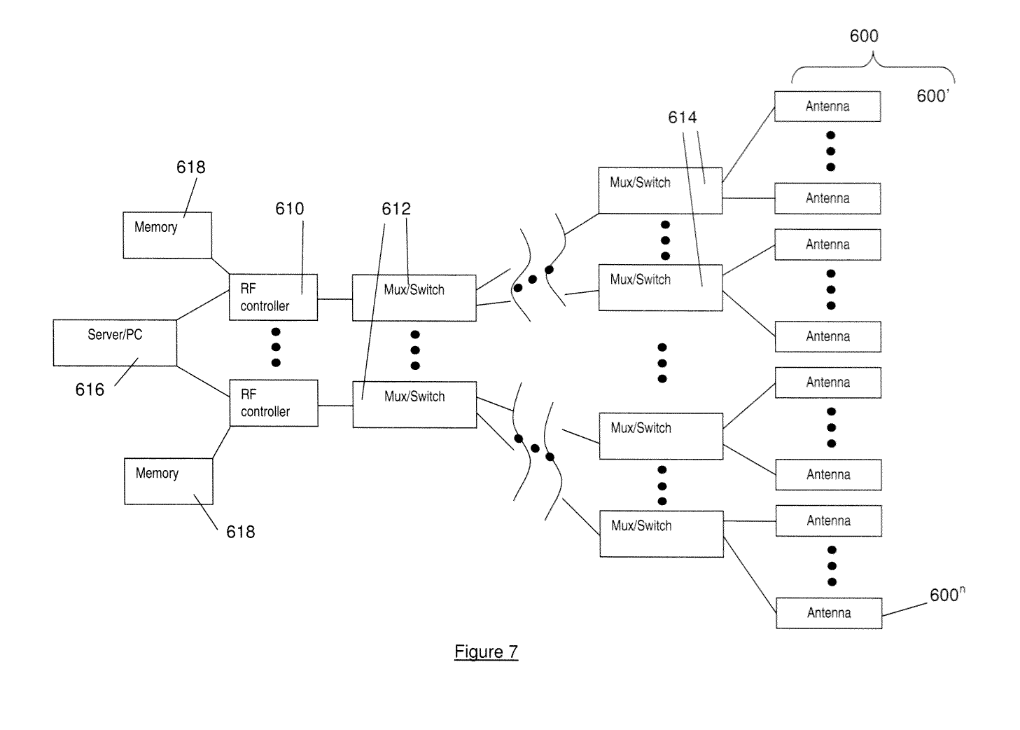

A system architecture is proposed which reveals a method of inter-connect and installation of the 3D antenna 600 for easy integration into existing inventory systems or setting up new management systems such as the architecture of FIG. 4 and this is shown in FIG. 7 with the antennas 102 being replaced with a plurality of the 3D antennas 600. The system of FIG. 7 also includes multiplexers 614,612 which are analogous to the front end and end stage multiplexers 500,502 of FIG. 4, RF controllers 610 which are similar to those 110 of FIG. 4, a host 616 and memory units 618 analogous to those 112,504 of FIG. 4. This system architecture not only focuses on the connections, but also a way to connect for minimal interference.

The performance of 3D antenna shown in FIG. 5 may be improved by changing the materials of the three standing wire loops 21, 22, 23 at the ends 602,604 and in the center 606 as shown in FIG. 6. The standing loops 21, 22 and 23 may be changed to another material or dimension according to the applications. The changing of materials and dimensions of the standing loops will change the magnetic flux distribution pattern. In this way, the 3D antenna 600 can adapt to different applications with flexibility of changing the antenna radiation pattern. To aid the magnetic field strength in the center 606 of the antenna 600, a coaxial cable or any other conductive material 24 can be connected from the far end 608 of the center loop 22 back to a feed point 26 (which is the near end 26 of the center loop 22, referring to FIG. 6) but not connecting to it. At the region near 26, the cable or conductive material is extended out as a free end 25. By changing the materials and dimensions of 21, 22, 23 and 24, the performance of the antenna can be changed accordingly to suit various applications.

The material 24 and the free end 25 are the connecting terminations for the 3D antenna 600. These ends are to be connected to a matching circuit (not shown) that will tune the impedance of the 3D antenna 600 to the conjugate impedance of the antennas 610 and the multiplexers/RF switches 612,614. This matching circuit not only functions as an impedance matching device, it also has integrated RF switching and filtering capabilities.

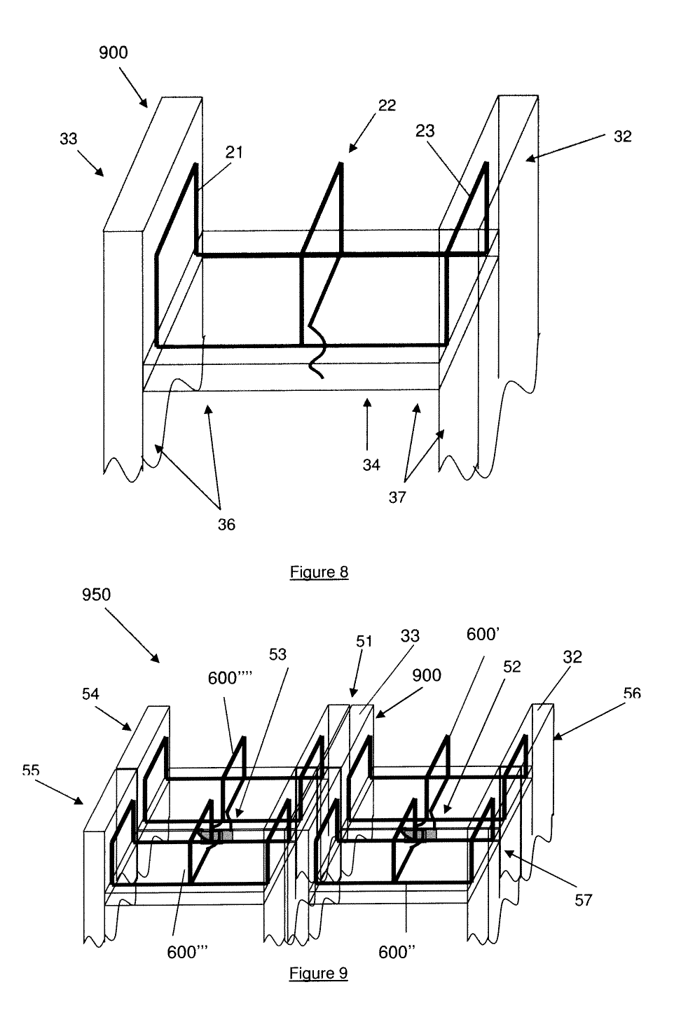

The integrated RF switching may be provided by an RF switch (not shown) comprising component such as PIN diode, FET or hybrid that may be controlled either by DC or RF signals. The RF switch is integrated into the matching circuit for the purpose of controlling the activation of the antenna 600. As shown in FIG. 8, the architecture includes a number of the antennas 600′, 600″, 600″′ . . . 600ⁿ with each antenna 600 having their respective RF fields interrogating corresponding transponders or tags. During operations, one antenna 600 would be turned on at one time, take for example, the first antenna 600′ which is the operating antenna. When this antenna 600′ is activated, the radiation from this antenna 600′ may be coupled into a nearby antenna 600″. This may cause the neighboring antennas 600″, 600″′ etc to be activated and thus energizing the tags in those antenna fields. The backscatter of these tags in the field of the other antennas 600″,600″′ may be fed into the operating antenna 600′ causing reading of tags in the neighboring shelves. The result is that there would more tags reported than there actually are.

The above problem is addressed by providing the RF switch so that only the operating antenna 600′ is energized. This may be achieved either by sending a DC bias to the matching circuit of the operating antenna 600′ and thus opening its RF switch. Thereafter, a DC return path may be designed to couple the DC back to ground and not sending it into the operating antenna 600′. Another way is to design a switch that can be activated by a pre-designed threshold of RF signal level. Other neighboring antennas 600″,600″′ etc receiving the unintentional radiation would not be turned on due to the reduced radiation since the distance is not strong enough to turn their integrated RF switches on. Either way, the aim of interference immunity of neighboring antennas from the operating antenna may be achieved. This is one way not only to reduce the interference on neighboring antennas, but also will increase the reading speed of the architecture as the architecture does not need to provide post processing of the data collected to remove the extra entries caused by the backscattering of the neighboring tags.

In additional to the matching and RF switch, a pass band filter is also incorporated into the design of the matching circuit. This filter has the function of only allowing frequencies in the operating range to pass through either way. In this way, the interference from external sources would not add noise into the system.

To place the 3D antenna 600 in a shelf 900, the 3D antenna 600 is configured to fit the dimension of the shelf 900. However, the shape and design of the 3D antenna 600 can remain the same. The size may be altered to fit into most shelves. One example is shown in FIG. 8. The 3D antenna 600 sits on the shelf 900 with both end loops 21,23 at the sides 32,33 of the shelf 900. The ends 21,23 of the antenna 600 may either be flushed to the sides 32,33, embedded or lying on the inner wall. The center loop 22 is standing in the middle of the shelf 900. The whole antenna 600 may be either installed together with the shelf 900 or it may be added in as a modular unit into an existing shelf 900. To prevent interference to neighboring shelves, metal sheets may be placed at the sides 32,33 of the shelf 900. The metal sheets may either be embedded into the shelf 900 or be affixed to the sides 32,33. This prevents interference going pass the side walls 32,33 of the shelves 900. If the shelf 900 is made of metallic materials, then such metallic shielding sheets would not be required. Similarly, to prevent interference from going into or coming in from shelves on the top and bottom, metallic sheet shielding can be added to the base 34 of the shelf 900. This metallic sheet is not required if the tray is made of metallic materials.

To prevent cross-talk among antennas, structure of the 3D antenna is using short circuit concept instead of traditional open loop concept. With short circuit design the input impedance is lower and it decreases interference and noise immunity.

Another methodology for prevent cross-talk among antennas is using open circuit concept for matching circuit. It means when the antenna is not powered, the matching circuit is opened and cut off signal path between match circuit and antenna. There will be no signal flow from antenna to the antenna.

In order to reduce costs, copper wire is chosen for antenna material. It is low cost, has High Q and better readability. It is also easy to emboss into structure. This has advantageous over traditional etched PCB which is commonly used but is high cost (most of material is etched and removed) and low Q.

The placement of the matching circuit may be placed at the base 34 for convenience. However, the matching circuit be placed at any other locations of the shelf 900. When this is to be done, the interference and matching has to be taken care to ensure stability of the system. The coaxial cable linking the matching circuit to the multiplexer/switch or antenna can be wired in an alternate fashion on either casing 36 or 37. This means that if a shelf on top of the shelf 900 is wired to the left, the next level can be wired to the right. However, this order can be changed or all the cables can be bundled together and all going through the same path. When this is done, the inter cable interference has to be taken care of. Proper shielding would be needed to ensure the reliability of the system. The cables can be shielded by either placing metallic material or RF absorbers such as ferrite sheets over them to prevent unnecessary radiated interference.

FIG. 9 illustrates an example of an assembly of shelves 950 including the shelf 900 placed side by and back to back. This shelving method can extend to multiple shelves on either side with each shelf carrying an antenna 600′,600″,600″′, 600″″. The back of the antenna, which is the side that houses the matching circuit between each shelf at 52 and 53, is faced on the inside of the arrangement. All the matching circuits would face each other and this would prevent the matching circuits from being in the presence of users. As in FIG. 8, metallic shielding can be placed at ends 51,54,55,56,57 of the shelves to prevent interference caused by neighboring shelves. This structure of arrangement can only be achieved if the antennas are closed loop design like the antenna in FIG. 5. If not, then additional shielding has to be placed between back to back antennas.

The unique 3D antenna design is capable of reading all the tags placed in multiple or any orientations in the shelf 900 with only one antenna per shelf instead of the usual two or more. This can cut down cost, reduce reading time and simplify processing algorithm. The matching circuit not only acts as a tuning device for tuning the impedance of the antenna to the conjugate impedance of the antenna/multiplexer, but also serve as a noise filter with RF switching function. The antenna has both local memory and processor to control the cascaded multiplexers and thus antennas. This decreases the demand on the host 112. This can translate into cheaper host and lower traffic. The combined architecture increase the reading speed, reliability of the system, cut down cost on expensive hardware, simplify processing algorithm and reduce the complexity of installation.

Advantages are realisable through various aspects. For example, the structure of the 3D antenna is unique. It increases interference and noise immunity and achieve multiple read orientation with one antenna instead of multiple antennas. The antenna structure is preferably a short circuit configuration so that there is less interference & cross talk. The antenna material may be copper wire, which is low cost, has high Q and better readability, as well as suitable for easy embossing into the shelf structure. The matching circuit combines matching, RF switch and pass band filter circuitry. The provision of a master clock from antenna synchronizes system scheduling and timing. Multiplexers 612,614 receive direct receive command from the RF controllers 610 instead of the host 616. In terms of the middleware, an array list structure is used instead of an auto-configure cascade structure. Localization Memory is provided through having residential memory to store RFID data. Thus data is sent to the host 616 when needed, thereby reducing processing time. The RF controller possesses not only RFID transceiver, but also localized memory and processor for storage and also control of the cascaded multiplexers and antennas with synchronized clocking. The system architecture reveals a method of inter-connect and installation for easy integration into existing inventory systems or setting up new management systems. This system not only focuses on the connections, but also a way to connect for minimal interference

Thus, advantageously, with the proposed system, a single 3D antenna with the capability of reading multiple orientations of tags placed in the field of the antenna per shelf is described. This eliminates the requirement of multiple antennas per shelf. In addition, proposed is a systematic way to integrate various devices into a RFID system which also addresses interference issues not adequately addressed in the prior art. Finally, due to the unique combination of the antenna and system integration, the reliability, readability and speed can be improved without additional cost to be incurred.

The proposed RFID asset management system makes use of a specially designed closed-loop antenna structure to read the tags on items placed in the shelf. This unique antenna may cover a range of 90 cm (full length of a conventional library shelf) and can read tags in multiple orientations (standing up, lying down, diagonal, facing out). In addition, due to the close loop design of the antenna, the ability to tolerate interference is higher than conventional loop antenna designs. Combining with RF switches in the matching circuit, the antenna can be turned on and off according to the application.

Aspects of the proposed system includes: A 3D antenna structure as shown in FIG. 5. The materials and variable dimensioning of the parts 21, 22, 23 and 24 of the antenna 600 to achieve different performance of the antenna in FIG. 6. The position of the feed points 25 and 26 for the 3D antenna 600. The method of installation of 3D antenna 600 into the shelf 900 shown in FIG. 8. The method to install shielding for the antenna from interfering or accepting interference. The position of the matching circuit at the base 34 of the shelf 900. The method of connecting the matching circuit to the antenna. The arrangement of the antennas in a collective assembly of shelves in FIG. 9. The placement of the matching circuit at 52 and 53 in that arrangement. Short circuit concept for antenna structure: Short Circuit Concept. Open circuit concept for matching circuit: Residential memory to store RFID data. Array list structure middleware. The method of shielding in FIG. 9. Architecture of the system in FIG. 7. The capabilities of RF controllers 610 and multiplexers 612,614 to synchronize clocking and control.

Specifically, there is provided an antenna arrangement comprising;

a first loop conductor segment which extends along a first axis and having first segment ends;

a second loop conductor segment which extends along a second axis and having second segment ends;

a third loop conductor segment which extends along a third axis and having third segment ends,

wherein the first, second and third segment ends being attached to each other to enable the first loop conductor segment, the second loop conductor segment and the third loop conductor segment to form one closed loop antenna.

Preferably, the first, second and third axes extends along the same general direction. Preferably, the second loop conductor segment is arranged between the first loop conductor segment and the second loop conductor segment.

Application areas include: warehouse inventories tracking, temperature and time sensitive assets, medical and health care environments, hazardous environments, consumer goods, industrial goods, energy utilities, oil & gas, hospitality services, medical devices, IT services, transportation services.

The described embodiments should not be construed as limitative. For example, the sensing circuit 106 may be adapted accordingly to suit different applications. For example, the low pass filter 116, the buffer 118 and/or the ADC 120 may be omitted or included accordingly. The RF antenna 102 may be an antenna or a transducer.

Also, instead of RFID, other transponders may also be used to tagging to the subjects.

In the described embodiments, the subject may be a person whereas the targets are items or articles and thus, they refer to different “things”. However, it is envisaged that the subject and target may comprise the same “things” for example, detecting if a book is being removed based on the detuning of the antenna 102 (or 600), and this is used to trigger an inventory check of al the “things” i.e. books etc. Also, the “subject” and “targets” may refer to humans, animals or moving objects etc.

Indeed, although the described embodiments generally refer to tracking location of items, this may be extended to humans or animals and applications beyond asset management. For example, the proximity sensing apparatus 100 may be configured to be used with a vehicle. Based on the amount of detuning of the antenna 102, it is possible to detect if a person is present within the vicinity of the vehicle and if yes, the proximity sensing apparatus 100 can trigger interrogation of a transponder, which may be an ID tag associated with the vehicle key. If the key is detected, then this may enable the vehicle to open the car door automatically, as in a “keyless” entry. On the other hand, if the vehicle key is not detected, the vehicle remains locked.

Having now fully described various embodiments of the proposed method and apparatus, it should be apparent to one of ordinary skill in the art that many modifications can be made hereto without departing from the scope as claimed.

1. Proximity detection apparatus comprising
a radio frequency (RF) antenna configured to transmit a RF signal for sensing presence of a subject;
a sensing circuit configured to detect detuning of the RF antenna and to derive a parameter associated with the RF signal which is representative of the detuning; and
a control system configured to compare the parameter with a threshold and based on the comparison, determine whether to control the RF antenna to transmit a signal for initiating a predetermined event.

2. Proximity detection apparatus according to claim 1, wherein the parameter is selected from the group consisting of frequency, phase and amplitude of the RF signal.

3. Proximity detection apparatus according to claim 1, wherein the apparatus is for tracking locations of targets tagged with respective transponders, and wherein the predetermined event includes interrogation of the transponders to determine the locations of the corresponding targets, the control signal being used to trigger the interrogation.

4. Proximity detection apparatus according to claim 3, wherein the targets are selected from at least one of the group consisting of objects, human beings and animals.

5. Apparatus according to claim 1, wherein the sensing circuit includes a filter for filtering the return loss component to obtain a filtered actuating signal.

6. Apparatus according to claim 5, wherein the filter includes a low pass filter for attenuating high frequency noise components.

7. Apparatus according to claim 5, wherein the sensing circuit includes a buffer for buffering the filtered actuating signal to produce a buffered actuating signal.

8. Apparatus according to claim 6, wherein the sensing circuit includes an analog-to-digital converter for digitizing the buffered actuating signal to produce the actuating signal.

9. Apparatus according to claim 1, further comprising a RF controller for switching the RF antenna between a first mode for sensing of the subject and a second mode for transmitting the signal in response to a triggering signal.

10. Apparatus according to claim 1, wherein the subjects is selected from at least one of the group consisting of objects, human beings and animals.

11. Proximity detection method comprising
transmitting a RF signal by a RF antenna for sensing presence of a subject; detecting detuning of the RF antenna;
deriving a parameter associated with the RF signal which is representative of the detuning; and
comparing the parameter with a threshold and based on the comparison, determining whether to control the RF antenna to transmit a signal for initiating a predetermined event.

12. An asset management apparatus, comprising
a proximity detection apparatus comprising:
a radio frequency (RF) antenna configured to transmit a RF signal for sensing presence of a subject;
a sensing circuit configured to detect detuning of the RF antenna and to derive a parameter associated with the RF signal which is representative of the detuning; and
a control system configured to compare the parameter with a threshold and based on the comparison determine whether to control the RF antenna to transmit a signal for initiating a predetermined event;
a plurality of the RF antennas, each RF antenna transmitting a RF signal for detecting presence of a said subject,
a plurality of multiplexer switches with each multiplexer switch communicatively coupled to some of the RF antennas, the multiplexer switch being configured to selectively allow each RF antenna to communicate with the control system in order for the respective parameters to be obtained, wherein the control system is configured to compare the respective parameters with the threshold and to generate the signal for interrogating transponders tagged to targets to determine locations of the targets.
